(19) United States
(12) Patent Application Publication
(10) Pub. No.: US 2026/0067363 A1
(43) Pub. Date: Mar. 5, 2026

(54) SYSTEMS AND METHODS FOR MONITORING USAGE OF AN INTERNET OF THINGS DEVICE WITHIN AN INTERNET OF THINGS NETWORK

(71) Applicant: Wells Fargo Bank, N.A., San Francisco, CA (US)

(72) Inventors: Steven A. Jolley, Chester, SC (US); Scott D. Hutula, Concord, NC (US); Deepak Elias, Wilton Center, CT (US); Maximilian Fuchs, Charlotte, NC (US); Tatiana Argabright, Rock Hill, SC (US); Himanshu Goyal, Fort Mill, SC (US)

(21) Appl. No.: 18/823,314

(22) Filed: Sep. 3, 2024

(51) Int. Cl. H04L 67/12; G16Y 40/10; G16Y 40/20

(52) U.S. Cl. CPC H04L 67/12; G16Y 40/10; G16Y 40/20

(57) ABSTRACT

Systems, apparatuses, methods, and computer program products are disclosed for monitoring usage of an IoT device within an IoT network. An example method includes receiving IoT device data comprising at least an IoT device type. The example method further includes determining, based on the IoT device type, a protocol configured to monitor usage of the IoT device. The example method further includes monitoring, based on the protocol, the usage of the IoT device. In response to monitoring the usage of the IoT device, the example method further includes generating, using a generative machine learning model and based on the usage of the IoT device, an IoT device recommendation for the IoT device.

### BACKGROUND

An internet of things (IoT) device is any physical object embedded with sensors, software, other technologies, and is specifically used for exchanging data with other devices and systems over various communications networks. An IoT network is a system of interconnected IoT devices that communicate and exchange data with each other, central servers, and/or cloud-based systems.

### BRIEF SUMMARY

Energy and maintenance management systems encompass a set of methodologies, technologies, and tools that are designed to analyse and interpret energy usage data. In personal user environments, such systems often require users to provide data (e.g., list of appliances, billing details, occupancy schedules, etc.) required for optimizing energy efficiency. Conventional energy and maintenance management systems, such as those provided by energy and maintenance management system providers, operate by gathering usage data associated with the energy-consuming devices of a user environment. The process of analyzing the digital footprint of a user environment is crucial for generating accurate recommendations for efficiency and optimization of the energy-consuming devices. However, conventional energy and maintenance management systems typically lack the ability to integrate with diverse appliances, whilst securely handling and analyzing large volumes of data from numerous diverse appliances (and/or other devices), often leading to inaccurate energy usage data collection. Furthermore, the manual nature of the analysis required for generating energy usage recommendations is burdensome and unsustainable over long periods of time. This manual effort necessitates recurring user interactions with individual appliances, causing delays in implementing cost-reduction strategies, increased administrative workload, increased power consumption as devices may not be optimally configured, and a higher potential for human error (e.g., personal bias, prejudice, subjectivity, oversight, etc.) in data analysis. Moreover, inconsistencies in how energy usage data is collected and interpreted can result in subjective energy usage recommendations, affecting the fairness and accuracy of the energy usage recommendation generation process.

Additionally, conventional energy and maintenance management systems often require users to manually interact with each individual appliance present in a user environment to obtain information about that specific device. Such a fragmented approach means that users cannot leverage the interconnected nature of a user environment to obtain comprehensive data or insights about the IoT network as a whole. Additionally, users may be required to navigate different user interfaces and menu structures for each different device. Further, they are unable to use any single appliance within the user environment to access aggregated data for the entire user environment or to answer specific queries related to overall energy usage patterns, cost-saving opportunities, or system-wide performance. This lack of integration and holistic visibility results in inefficiencies and missed opportunities for optimizing energy and maintenance management across all connected appliances. As such, there is a unique need for a technical solution that functions independently of any manual activity of a user, and that can systematically and automatically provide users with energy efficiency recommendations tailored for the individual appliances present in the user environment. A solution of this nature would be intractable without a systematic and computer-based implementation. Accordingly, there is a latent technical need for systems that can automatically provide this capability.

Example implementations described herein provide a technical solution to this technical problem, and in doing so, overcome the challenges presented by the manual analysis of energy usage data in generating targeted insights. Example embodiments described herein employ an internet of things (IoT) device usage monitoring system, which includes an analytics engine and a generative machine learning model. In conjunction with the analytics engine, the generative machine learning model analyzes a historical usage trend, ongoing usage trend, and a projected usage trend of the IoT device to generate an IoT device recommendation. As such the analytics engine and generative machine learning model enable improved and more accurate generation of IoT device recommendations, and in doing so, allow for reduced expenditure of manual, financial, and computational resources associated with the personalized generation of IoT device recommendations for various user environments. Additionally, the analytics engine and generative machine learning model can reduce power consumption of such IoT devices and may prolong the battery life of battery-powered devices and/or devices with battery backup.

Accordingly, the present disclosure sets forth systems, methods, and apparatuses that provide improved systems and techniques for energy and maintenance management systems. There are many advantages of these, and other, embodiments described herein over the conventional systems described above.

One advantage is that example embodiments provide an improvement to the functioning of the computing infrastructure of an IoT network by reducing the burden on computing resources and/or power consumption. Example embodiments may accomplish this by, among other things, providing a centralized and/or unified system (e.g., software application, hub device, etc.) capable of monitoring each IoT device and, thus, reduce the burden on the available computing infrastructure associated with system redundancies caused by having to manually access each IoT device individually. In addition, such a centralized and/or unified system can reduce local network traffic because data collection from each IoT device can be orchestrated so as to reduce demand (e.g., transient spikes, etc.) in available communications network bandwidth usage that can lead to delays, lag, and/or excessive buffering.

Another advantage is that example embodiments provide an improvement to energy and maintenance management system technologies and/or Artificial Intelligence (AI) system technologies by incorporating a generative machine learning model which can be leveraged for objective (e.g., empirical based, unbiased, etc.) data collection (e.g., for overall energy usage patterns, cost-saving opportunities, system-wide performance, etc.) and/or objective decision making (e.g., appliance upgrades, appliance downgrades, maintenance scheduling, filter/part replacement, configuration modification, etc.). Example embodiments may accomplish this by compiling information related to each systems hardware (e.g., type, model, size, capacity, etc.), software (e.g., Operating System (OS), computing environment, etc.), available computational resources (e.g., processing power, network capacity, etc.), usage (e.g., user interactions, run-times, utilization versus total capacity, remaining life expectancy, etc.), and/or the like. Example embodiments may accomplish this by, among other things, monitoring (e.g., periodically, in real-time, near-real-time, etc.) the user usage (e.g., air conditioner duty cycle, number of times a refrigerator door opens, smart television watch time, etc.) of one or more IoT devices (e.g., air conditioner, refrigerator, smart television, etc.).

The foregoing brief summary is provided merely for purposes of summarizing some example embodiments described herein. Because the above-described embodiments are merely examples, they should not be construed to narrow the scope of this disclosure in any way. It will be appreciated that the scope of the present disclosure encompasses many potential embodiments in addition to those summarized above, some of which will be described in further detail below.

### BRIEF DESCRIPTION OF THE FIGURES

Having described certain example embodiments in general terms above, reference will now be made to the accompanying drawings, which are not necessarily drawn to scale. Some embodiments may include fewer or more components than those shown in the figures.

FIG. 1 illustrates a system in which some example embodiments may be used for monitoring usage of an internet of things (IoT) device within an IoT network.

FIG. 2 illustrates a schematic block diagram of example circuitry embodying a system device that may perform various operations in accordance with some example embodiments described herein.

FIG. 3 illustrates an example flowchart for monitoring usage of an internet of things (IoT) device within an IoT network, in accordance with some example embodiments described herein.

FIG. 4 illustrates an example flowchart for determining, based on the IoT device type, a protocol configured to monitor usage of the IoT device, in accordance with some example embodiments described herein.

FIG. 5 illustrates an example flowchart for generating, using a generative machine learning model and based on the usage of the IoT device, an IoT device recommendation for the IoT device, in accordance with some example embodiments described herein.

FIG. 6 illustrates a graphical user interface of an IoT device, in accordance with some example embodiments described herein.

### DETAILED DESCRIPTION

Some example embodiments will now be described more fully hereinafter with reference to the accompanying figures, in which some, but not necessarily all, embodiments are shown. Because inventions described herein may be embodied in many different forms, the invention should not be limited solely to the embodiments set forth herein; rather, these embodiments are provided so that this disclosure will satisfy applicable legal requirements.

The term “computing device” refers to any one or all of programmable logic controllers (PLCs), programmable automation controllers (PACs), industrial computers, desktop computers, personal data assistants (PDAs), laptop computers, tablet computers, smart books, palm-top computers, personal computers, smartphones, wearable devices (such as headsets, smartwatches, or the like), and similar electronic devices equipped with at least a processor and any other physical components necessarily to perform the various operations described herein. Devices such as smartphones, laptop computers, tablet computers, and wearable devices are generally collectively referred to as mobile devices.

The term “server” or “server device” refers to any computing device capable of functioning as a server, such as a master exchange server, web server, mail server, document server, or any other type of server. A server may be a dedicated computing device or a server module (e.g., an application) hosted by a computing device that causes the computing device to operate as a server.

The term “internet of things device” or “IoT device” refers to a physical object embedded with sensors, software, and other technologies that is enabled to collect, transmit, and receive data over an IoT network. Such IoT devices may be capable of interacting with other devices and systems through the internet, facilitating real-time monitoring, control, and automated functionalities. Examples of IoT devices may include smart home appliances such as refrigerators, air conditioning units, televisions, dishwashers, etc.

The term “internet of things network” or “IoT network” refers to a system of interconnected IoT devices that communicate with each other and with centralized systems via the internet. The IoT network may enable the seamless exchange and analysis of data between IoT devices, supporting functionalities such as real-time monitoring, remote control, and data-driven decision-making to enhance operational efficiency and user experience. Examples of an IoT network include smart home environments. An IoT network does not refer to the supporting infrastructure that enables the IoT network to operate (e.g., routers, switches, modems, etc.).

The term “IoT device data” refers to the information collected, transmitted, and received by an IoT device within an IoT network. Examples of IoT device data includes operational metrics, environmental conditions, status updates, details about the IoT device's features and capabilities, and metadata related to the IoT device itself.

The term “IoT device database” refers to a structured repository that stores, organizes, and manages information about one or more IoT devices within an IoT network. The IoT device database may include detailed records for each IoT device, capturing critical attributes such as IoT device type, network configuration, operational status, and other relevant metrics. The IoT device database may facilitate the efficient monitoring, management, and analysis of IoT devices, enabling functionalities such as IoT device identification, IoT device data aggregation, IoT device performance tracking, and generation of actionable insights. In some examples, the IoT device database may comprise a profile for each IoT device. In such examples, the profile may comprise some or all attributes (e.g., usage data, unique identifier, operating costs, etc.) recorded for the respective IoT device. The IoT device database may support real-time data updates and retrieval, ensuring that the IoT device data remains current and accurate for decision-making processes and generation of recommendations based on the IoT devices present in the IoT network.

The term “usage type ratio” refers to a quantifiable measure that indicates the relative importance and allocation of usage monitoring resources between the primary usage parameter and secondary usage parameter of an IoT device. In other words, the term “usage type ratio” represents the proportion of focus dedicated to active (primary usage) versus passive (secondary usage) monitoring, guiding the analytics engine 208 in prioritizing its monitoring resources.

The term “protocol” refers to a set of predefined rules, procedures, and parameters that dictate how the analytics engine monitors usage of an IoT device within an IoT network.

The term “IoT device recommendation” refers to a usage data-driven recommendation for optimizing the cost-effectiveness, usage, efficiency, and other relevant parameters of an IoT device.

The term “user request” refers to a query submitted by a user seeking a specific insight or recommendation related to the usage of an IoT device within an IoT network. The request may include queries associated with optimization of IoT device performance, cost reduction, improving efficiency of the IoT device, and/or the like.

### System Architecture

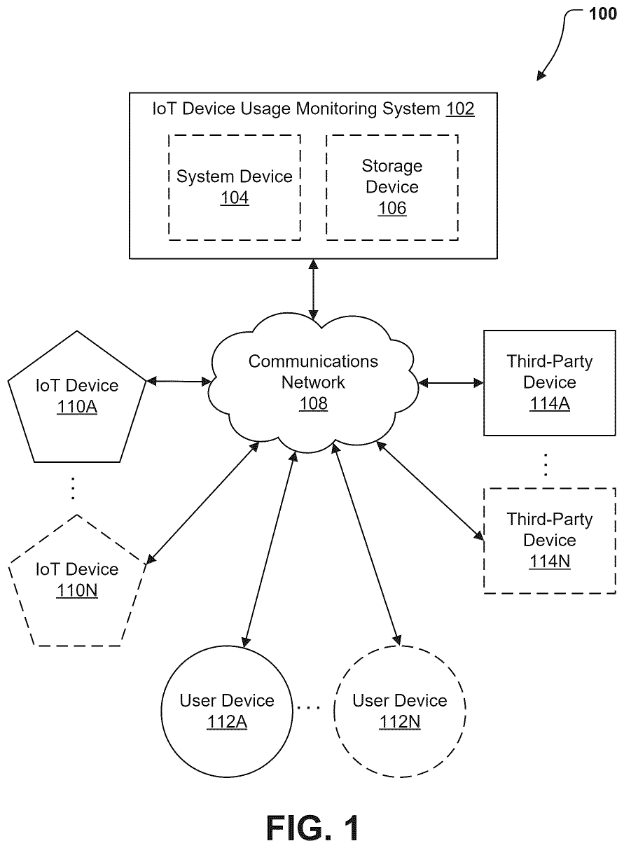

Example embodiments described herein may be implemented using any of a variety of computing devices or servers. To this end, FIG. 1 illustrates an example environment 100 within which various embodiments may operate. As illustrated, an IoT device usage monitoring system 102 may receive and/or transmit information via communications network 108 (e.g., the Internet) with any number of other devices, such as one or more of IoT devices 110A-110N, user devices 112A-112N, and/or third-party devices 114A-114N. Although system device 104 and storage device 106 are described in singular form, some embodiments may utilize more than one system device 104, more than one storage device 106, and/or the like. The one or more IoT devices 110A-110N, user devices 112A-112N, and/or third-party devices 114A-114N, may be embodied by any computing devices known in the art. The one or more IoT devices 110A-110N, user devices 112A-112N, and/or third-party devices 114A-114N need not themselves be independent devices but may be peripheral devices communicatively coupled to other computing devices. The one or more IoT devices 110A-110N may include smart appliances (e.g., refrigerators, ovens, washer and dryers, thermostats, televisions, plugs, lights, security cameras, dishwashers, coffee makers, etc.). The one or more user devices 112A-112N may include laptops, tablets, phones, whereas the one or more third-party devices 114A-114N may be a device associated with a third-party that performs operations based on the IoT device recommendation.

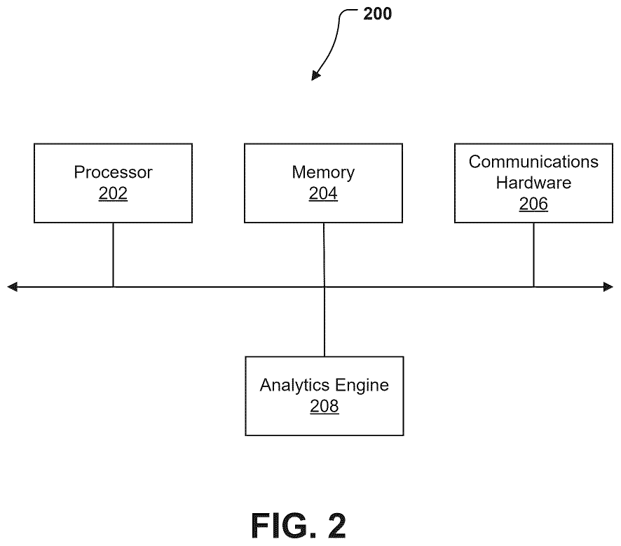

The IoT device usage monitoring system 102 may be implemented as one or more computing devices or servers, which may be composed of a series of components. These components of system device 104 may be physically proximate to the other components of the IoT device usage monitoring system 102, while other components are not. The system device 104 may receive, process, generate, and transmit data, signals, and electronic information to facilitate the operations of the IoT device usage monitoring system 102. Particular components of the IoT device usage monitoring system 102 are described in greater detail below with reference to apparatus 200 in connection with FIG. 2.

In some embodiments, the IoT device usage monitoring system 102 further includes a storage device 106 that comprises a distinct component from other components of the IoT device usage monitoring system 102. Storage device 106 may be embodied as one or more direct-attached storage (DAS) devices (such as hard drives, solid-state drives, optical disc drives, or the like) or may alternatively comprise one or more Network Attached Storage (NAS) devices independently connected to a communications network (e.g., communications network 108). Storage device 106 may host the software executed to operate the IoT device usage monitoring system 102. Storage device 106 may store information relied upon during operation of the IoT device usage monitoring system 102, such as the usage of IoT devices within an IoT network that may be used by the IoT device usage monitoring system 102. In addition, storage device 106 may store control signals, device characteristics, and access credentials enabling interaction between the IoT device usage monitoring system 102 and one or more of the IoT devices 110A-110N, user devices 112A-112N, and/or the third-party devices 114A-114N.

### Example Implementing Apparatuses

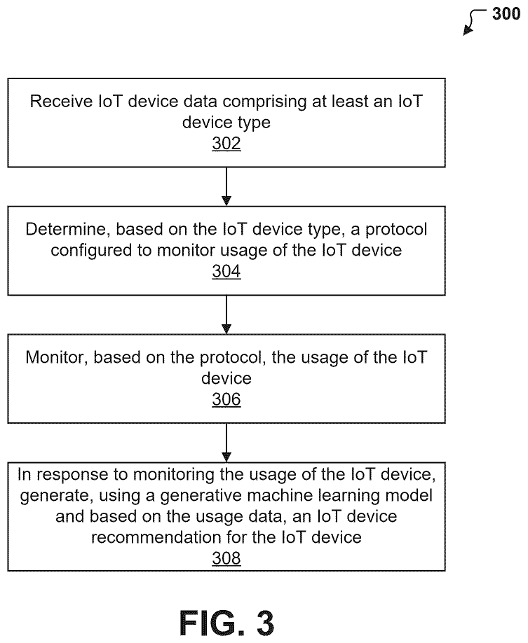

The IoT device usage monitoring system 102 (described previously with reference to FIG. 1) may be embodied by one or more computing devices or servers, shown as apparatus 200 in FIG. 2. The apparatus 200 may be configured to execute various operations described above in connection with FIG. 1 and below in connection with FIGS. 3-6. As illustrated in FIG. 2, the apparatus 200 may include processor 202, memory 204, communications hardware 206, and analytics engine 208, each of which will be described in greater detail below. In some examples, the apparatus 200 may comprise one or more of a smartphone, IoT hub device, smart home assistant device, a server, and/or any other computing device for monitoring one or more IoT devices as described herein.

The processor 202 (and/or co-processor or any other processor assisting or otherwise associated with the processor) may be in communication with the memory 204 via a bus for passing information amongst components of the apparatus. The processor 202 may be embodied in a number of different ways and may, for example, include one or more processing devices configured to perform independently. Furthermore, the processor may include one or more processors configured in tandem via a bus to enable independent execution of software instructions, pipelining, and/or multithreading. The use of the term “processor” may be understood to include a single core processor, a multi-core processor, multiple processors of the apparatus 200, remote or “cloud” processors, or any combination thereof.

The processor 202 may be configured to execute software instructions stored in the memory 204 or otherwise accessible to the processor. In some cases, the processor may be configured to execute hard-coded functionality. As such, whether configured by hardware or software methods, or by a combination of hardware with software, the processor 202 represent an entity (e.g., physically embodied in circuitry) capable of performing operations according to various embodiments of the present invention while configured accordingly. Alternatively, as another example, when the processor 202 is embodied as an executor of software instructions, the software instructions may specifically configure the processor 202 to perform the algorithms and/or operations described herein when the software instructions are executed.

Memory 204 is non-transitory and may include, for example, one or more volatile and/or non-volatile memories. In other words, for example, the memory 204 may be an electronic storage device (e.g., a computer readable storage medium). The memory 204 may be configured to store information, data, content, applications, software instructions, or the like, for enabling the apparatus to carry out various functions in accordance with example embodiments contemplated herein.

The communications hardware 206 may be any means such as a device or circuitry embodied in either hardware or a combination of hardware and software that is configured to receive and/or transmit data from/to a network and/or any other device, circuitry, or module in communication with the apparatus 200. In this regard, the communications hardware 206 may include, for example, a network interface for enabling communications with a wired or wireless communication network. For example, the communications hardware 206 may include one or more network interface cards, antennas, buses, switches, routers, modems, and supporting hardware and/or software, or any other device suitable for enabling communications via a network. Furthermore, the communications hardware 206 may include the processing circuitry for causing transmission of such signals to a network or for handling receipt of signals received from a network.

The communications hardware 206 may further be configured to provide output to a user and, in some embodiments, to receive an indication of user input. In this regard, the communications hardware 206 may comprise a user interface, such as a display, and may further comprise the components that govern use of the user interface, such as an IoT device, web browser, mobile application, dedicated client device, or the like. In some embodiments, the communications hardware 206 may include a keyboard, a mouse, a touch screen, touch areas, soft keys, a microphone, a speaker, and/or other input/output mechanisms. The communications hardware 206 may utilize the processor 202 to control one or more functions of one or more of these user interface elements through software instructions (e.g., application software and/or system software, such as firmware) stored on a memory (e.g., memory 204) accessible to the processor 202.

In some embodiments, the communications hardware may utilize processor 202 and/or memory 204 to receive IoT device data comprising at least an IoT device type, output the usage of the IoT device to an IoT device user interface, output the IoT device recommendation to a user, and transmit, to the IoT device, control instructions configured to modify a feature of the IoT device.

In addition, the apparatus 200 further comprises an analytics engine 208 that determines a protocol configured to monitor usage of the IoT device, monitors the usage of the IoT device based on the protocol, and generates, using a generative machine learning model and based on the usage of the IoT device, an IoT device recommendation for the IoT device. The analytics engine 208 may utilize processor 202, memory 204, or any other hardware component included in the apparatus 200 to perform these operations, as described in connection with FIGS. 3-6 below. The analytics engine 208 may further utilize communications hardware 206 to gather data from a variety of sources (e.g., IoT device 110A through IoT device 110N or storage device 106, as shown in FIG. 1), and/or exchange data with a user, and in some embodiments may utilize processor 202 and/or memory 204 to update an IoT device database to include the IoT device type. In some examples, analytics engine 208 may identify a usage parameter associated with the IoT device. In some examples, analytics engine 208 may classify the usage parameter as a primary parameter or a secondary parameter. In some examples, analytics engine 208 may determine a usage type ratio based on the primary parameter and the secondary parameter. In some examples, analytics engine 208 may determine the protocol using the generative machine learning model and the usage type ratio. In some examples, analytics engine 208 may generate, using the generative machine learning model, an IoT device recommendation based on an analysis of one or more of (i) a historical usage trend, (ii) an ongoing usage trend, and (iii) a projected usage trend. In some examples, analytics engine 208 may generate, based on the IoT device recommendation, control instructions configured to modify a feature of the IoT device.

Although components 202-208 are described in part using functional language, it will be understood that the particular implementations necessarily include the use of particular hardware. It should also be understood that certain of these components 202-208 may include similar or common hardware. For example, the analytics engine 208 may each at times leverage use of the processor 202, memory 204, or communications hardware 206, such that duplicate hardware is not required to facilitate operation of these physical elements of the apparatus 200 (although dedicated hardware elements may be used for any of these components in some embodiments, such as those in which enhanced parallelism may be desired). Use of the term “engine” with respect to elements of the apparatus therefore shall be interpreted as necessarily including the particular hardware configured to perform the functions associated with the particular element being described. Of course, while the term “engine” should be understood broadly to include hardware, in some embodiments, the term “engine” may in addition refer to software instructions that configure the hardware components of the apparatus 200 to perform the various functions described herein.

Although the analytics engine 208 may leverage processor 202, memory 204, or communications hardware 206 as described above, it will be understood that any of analytics engine 208 may include one or more dedicated processor, specially configured field programmable gate array (FPGA), or application specific interface circuit (ASIC) to perform its corresponding functions, and may accordingly leverage processor 202 executing software stored in a memory (e.g., memory 204), or communications hardware 206 for enabling any functions not performed by special-purpose hardware. In all embodiments, however, it will be understood that analytics engine 208 comprise particular machinery designed for performing the functions described herein in connection with such elements of apparatus 200. For example, in some embodiments, the apparatus 200 (e.g., a hub device or the like) may comprise one or more ASICs (and/or the like as described herein) to perform one or more respective operations described below in connection with FIGS. 3-6.

In some embodiments, various components of the apparatus 200 may be hosted remotely (e.g., by one or more cloud servers) and thus need not physically reside on the corresponding apparatus 200. For instance, some components of the apparatus 200 may not be physically proximate to the other components of apparatus 200. Similarly, some or all of the functionality described herein may be provided by third party circuitry. For example, a given apparatus 200 may access one or more third party circuitries in place of local circuitries for performing certain functions.

As will be appreciated based on this disclosure, example embodiments contemplated herein may be implemented by an apparatus 200. Furthermore, some example embodiments may take the form of a computer program product comprising software instructions stored on at least one non-transitory computer-readable storage medium (e.g., memory 204). Any suitable non-transitory computer-readable storage medium may be utilized in such embodiments, some examples of which are non-transitory hard disks, CD-ROMs, DVDs, flash memory, optical storage devices, and magnetic storage devices. It should be appreciated, with respect to certain devices embodied by apparatus 200 as described in FIG. 2, that loading the software instructions onto a computing device or apparatus produces a special-purpose machine comprising the means for implementing various functions described herein.

Having described specific components of example apparatus 200, example embodiments are described below in connection with a series of flowcharts and graphical user interfaces.

### Example Operations

Turning to FIGS. 3-6, example flowcharts and graphical user interfaces are illustrated that contain example operations implemented by example embodiments described herein. The operations illustrated in FIGS. 3-6 may, for example, be performed by system device 104 of the IoT device usage monitoring system 102 shown in FIG. 1, which may in turn be embodied by an apparatus 200, which is shown and described in connection with FIG. 2. To perform the operations described below, the apparatus 200 may utilize one or more of processor 202, memory 204, communications hardware 206, analytics engine 208, and/or any combination thereof. It will be understood that user interaction with the IoT device usage monitoring system 102 may occur directly via communications hardware 206 or may instead be facilitated by a user device (e.g., any of user devices 112A-112N), as shown in FIG. 1, and which may have similar or equivalent physical componentry facilitating such user interaction.

Turning first to FIG. 3, a procedure 300 illustrates example operations for monitoring usage of an internet of things (IoT) device within an IoT network, wherein the apparatus 200 includes means such as processor 202, memory 204, communications hardware 206, analytics engine 208, or the like.

As shown by operation 302, the apparatus 200 includes means such as communications hardware 206, or the like, for receiving IoT device data comprising at least an IoT device type. In order to receive the IoT device data, the communications hardware 206 may be configured to proactively establish a secure connection with an IoT device 110A from which the IoT device data may be transmitted. In some embodiments, the IoT device data may be transmitted from user devices 112A-112N, third-party devices 114A-114N, and/or the like. Additionally, the communications hardware 206 may be configured to automatically detect the addition of a new IoT device (e.g., any of IoT devices 110A-110N), and/or the continuous presence of an IoT device 110A already integrated into the IoT network. In such instances, the communications hardware 206 may execute an IoT device discovery mechanism to securely authenticate the IoT device 110A into the IoT network. In some embodiments, the IoT device discovery mechanism may involve the IoT device 110A broadcasting its presence using application programming interfaces (APIs), which may include standard discovery protocols such as multicast DNS (mDNS), Simple Service Discovery Protocol (SSDP), Bluetooth Low Energy (BLE) advertising, and/or the like. In alternate embodiments, the communications hardware 206 may continuously scan the IoT network to identify new IoT devices 110A-110N using techniques such as Address Resolution Protocol (ARP) scanning, which detects new IP addresses on the IoT network. Dedicated IoT protocols, such as MQTT or Constrained Application Protocol (CoAP), may also be used to detect an IoT device 110A within the IoT network.

Following the detection of an IoT device 110A, the communications hardware 206 may be configured to initiate a handshake process involving the exchange of initial security credentials (e.g., digital certificates, security tokens), to authenticate the IoT device 110A. For example, during the handshake process, the communications hardware 206 and the IoT device 110A may exchange security tokens using secure token exchange algorithms (e.g., Diffie-Hellman or Elliptic Curve Diffie-Hellman). This token exchange process ensures that both the IoT device 110A and the communications hardware 206 of the IoT device usage monitoring system 102 have a shared secret token for encryption and decryption of transmitted IoT device data.

Upon successful authentication of the IoT device 110A, the communications hardware 206 may initialize an ongoing secure session with the IoT device 110A. The ongoing secure session may be characterized by a unique session identifier specific to the IoT device 110A, and may include parameters such as session keys, encryption algorithms, and integrity checks. IoT device data transmitted between the communications hardware 206 and the IoT device may be encrypted using preestablished encryption algorithms and session keys. This form of encryption may prevent unauthorized access to the IoT device data during transmission. In some embodiments, the communications hardware 206 may continuously monitor the secure session for any anomalies or security breaches. If any suspicious actively is detected, the communications hardware 206 may terminate the session with the IoT device 110A and may rei-initiate a new secure session with the IoT device 110A. Additionally, in some embodiments, each IoT device data packet transmitted over the secure channel may include an integrity check (e.g., a message authentication code, hash-based message authentication code, etc.) that verifies that the IoT device data has not been tampered with during transmission.

IoT device data may include the following information: device identification data such as (i) device type—refrigerator, thermostat, smart lights, etc., (ii) manufacturer and model, (iii) unique device identifier—MAC address, serial number, (iv) firmware version, etc.; IoT device feature data such as (i) special features—ice maker, water dispenser, smart cooling technology, scheduling capabilities, connectivity options, etc., (ii) storage capacity—total volume, adjustable shelves, energy-saving modes, etc.; operational data such as (i) current status—on/off, active/inactive, etc., (ii) performance metrics—temperature settings, etc., (iii) diagnostic information—error codes, maintenance alerts, etc.; environmental data such as (i) temperature readings, (ii) humidity levels, (iii) light intensity, (iv) motion intensity); user interaction data such as (i) control commands, (ii) user preferences and settings, (iii) activity logs; network data such as connectivity status—connected/disconnected, IP address, network protocols used, signal strength and quality, and/or the like. In some examples, the IoT device data may be used to generate or compile a IoT device profile. In some such examples, the IoT device usage monitoring system 102 may store one or more IoT device profiles (e.g., to storage device 106 or the like as described herein) and/or update the one or more IoT device profiles as new IoT device data is captured.

The communications hardware 206 may identify the IoT device type via various methods. In some embodiments, the IoT device 110A may transmit IoT device data in XML or JSON formatted files which contain metadata about the IoT device 110A, comprising at least the IoT device type. In alternate embodiments, the IoT device 110A may use the Universal Plug and Play (UPnP) protocol to transmit IoT device data that comprises at least the IoT device type. The communications hardware 206 may cross-reference the MAC address of the IoT device 110A against known manufacturer/IoT device type databases, which may be used to infer the manufacturer and the IoT device type. In some embodiments, upon connecting to the IoT network, the IoT device 110A may transmit initial configuration or status messages to communications hardware 206, that comprises at least the IoT device type. Subsequent to receipt of such configuration or status messages, the communications hardware 206 may parse these messages to extract at least the IoT device type.

In some embodiments, the communications hardware 206 may be configured to receive IoT device data at regularly scheduled intervals via polling or scheduled data transmission mechanisms. For instance, using a polling mechanism, the communications hardware 206 may periodically transmit requests to the IoT device for updated IoT device data (e.g., addition or removal of features due to a software update). The interval for such requests may be preconfigured by the internal system of an IoT device 110A, may be manually configured by a user during integration of the IoT device 110A into the IoT network, or may be automatically configured by control instructions transmitted to the IoT device 110A based on specific requirements of the IoT device usage monitoring system 102. In some embodiments, the communications hardware 206 may be configured to receive IoT device data via scheduled IoT device data transmission at predefined intervals (e.g., every 5 minutes, hourly). A predefined schedule may be established during the initial configuration process of the IoT device 110A within the IoT network. In alternate embodiments, communications hardware 206 may receive the IoT device data, comprising at least the IoT device type, in response to a user-initiated transmission request, wherein the user-initiated transmission request is transmitted from a user device (e.g., user devices 112A-112N), or the user interface of the IoT device 110A.

In some embodiments, receiving the IoT device type may further comprise updating, by analytics engine 208, an IoT device database to include the IoT device type, wherein the IoT device database corresponds to the IoT network hosting the IoT device. In response to receiving the IoT device data, the communications hardware 206 may be configured to use an API (e.g., RESTful, MQTT, etc.) to transmit the parsed IoT device data to the analytics engine 208 for further processing. The analytics engine 208 may process the received IoT device data to identify at least the IoT device type. In some embodiments, the analytics engine 208 may verify the integrity and accuracy of the identified IoT device type against other attributes included in the IoT device data. The analytics engine 208 may maintain an internal database of common attributes associated with various IoT device types. For example, common attributes of an IoT device such as a smart refrigerator may include an ice maker, water dispenser, temperature control, energy consumption monitoring, door open sensor, etc. The analytics engine 208 may compare the attributes listed in the received IoT device data with the known features of a smart refrigerator. If the attributes align with those commonly found in smart refrigerators, the analytics engine 208 may confirm the identification of the IoT device type and then proceed with updating of the IoT device database.

Upon verification of the IoT device type, the analytics engine 208 may prepare a structured data entry (e.g., JSON, XML format), for updating the IoT device database with the IoT device type. In some embodiments, the analytics engine 208 may update the IoT device database with additional IoT device attributes such as manufacturer, model, unique identifiers, features, and/or the like. As an initial step, the analytics engine 208 may establish a secure connection with the IoT device database via a database connection API (e.g., JDBC, ODBC). Subsequently, the analytics engine 208 may execute an update command to update the IoT device information in the IoT device database using a database manipulation API (e.g., SQL). In response to updating the IoT device database to include the IoT device type, the analytics engine 208 may perform a final verification check to confirm that the IoT device database update was accurate and successful. The aforementioned step may be performed via a database query API (e.g., SQL SELECT).

In embodiments where the analytics engine 208 has identified an incorrect IoT device type or is unable to conclusively identify the IoT device type, the analytics engine 208 may flag the IoT device as “uncertain/incorrect IoT device type identification” and may record this status in the IoT device database. This flag may cause the communications hardware 206 to subsequently trigger an alert for manual review of the IoT device type by a user, in which case a prompt may be outputted by the communications hardware 206 to a user device 112A or a user interface on the IoT device 110A. Accordingly, a user may provide confirmation and/or a specification regarding the IoT device type in question. In alternate embodiments, the analytics engine 208 may request additional data from the IoT device 110A to gather more context about the IoT device type. The additional data may include operational parameters specific to the IoT device type, or other relevant unique features of the IoT device 110A. In some embodiments, the analytics engine 208 may further leverage an advanced machine learning model to analyze attributes and similarities of the IoT device data with other known devices in the IoT network and/or the IoT device database for identification of the correct IoT device type.

As shown by operation 304, the apparatus 200 includes means such as analytics engine 208, or the like, for determining a protocol configured to monitor usage of the IoT device. A protocol refers to the specific parameters, metrics, and methods for monitoring, collecting, analyzing, and reporting usage of an IoT device. The protocol may specify the types of usage parameters to be monitored, the frequency of data collection from the IoT device, thresholds for alerts, and actions to be taken in response to certain conditions. Execution of the protocol ensures consistency and accuracy of communication between an IoT device and the IoT device usage monitoring system, facilitates effective management, control, and optimization of IoT devices within an IoT network.

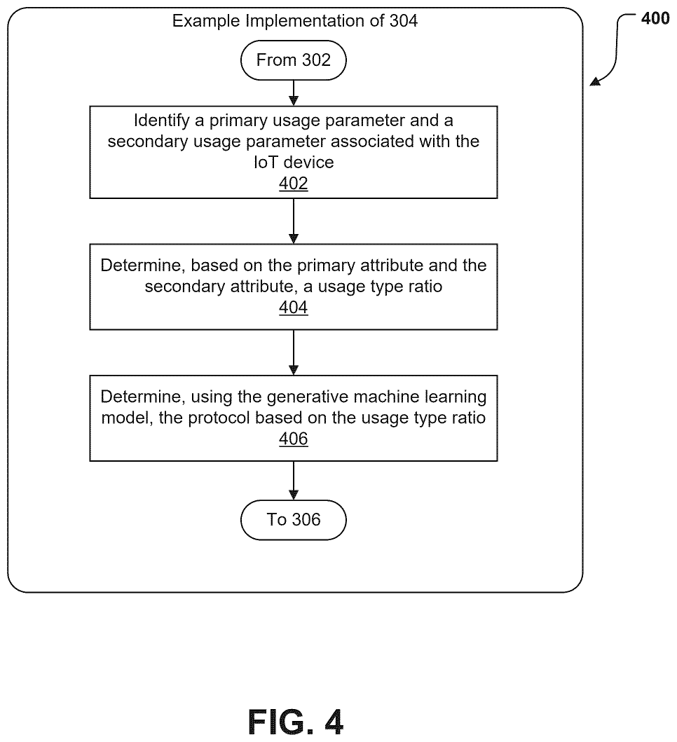

In some embodiments, operation 304 may be performed in accordance with the operations described in FIG. 4. Turning now to FIG. 4, a procedure 400 illustrates example operations for determining a protocol configured to monitor usage of the IoT device.

As shown by operation 402, the apparatus 200 includes means such as analytics engine 208, or the like, for identifying, based on the IoT device type, a primary usage parameter and a secondary usage parameter associated with the IoT device. The primary usage parameter refers to the active usage of an IoT device, reflecting its core functionality and performance. For example, the primary usage parameter of a smart refrigerator may be the time the smart refrigerator is actively cooling food items. In contrast, the secondary usage parameter refers to the passive usage of an IoT device, providing additional context and insights into the overall operation of the IoT device. For instance, the secondary usage parameter for a refrigerator may be the time the refrigerator door is open, or the passive energy consumption when the smart refrigerator is in standby mode.

To identify the primary usage parameter and secondary usage parameter of an IoT device, the analytics engine 208 may examine the operational characteristics associated with the IoT device type, to distinguish between active and passive functions. By way of continued example, the active functions for a smart refrigerator may include cooling cycles, compressor operations, and/or the like, whereas the relevant passive functions may include door open/close events, idle energy consumption, and/or the like. In some embodiments, the analytics engine 208 may refer to a preexisting IoT device type database, where the primary usage parameters and secondary usage parameters for a particular IoT device type are documented based on industry standards and historical data. Further, in alternate embodiments, the analytics engine 208 may use a generative machine learning model trained on historical data (e.g., IoT device profiles, etc.) from similar IoT device types to recognize patterns of active and passive usage and extrapolate the primary usage parameters and secondary usage parameters accordingly. Additionally, in some embodiments, the analytics engine 208 may identify the primary usage parameter and the secondary usage parameter based on the specific customized features of a particular IoT device. For instance, a smart refrigerator with a smart temperature control system may have additional primary usage parameters related to temperature regulation precision. In this context, additional primary usage parameters may include the frequency and duration of defrost cycles, the operation of humidity control features, and the activity of the rapid cooling or freezing functions. An example implementation for this scenario is described further below.

For example, consider a household with a smart refrigerator that features advanced temperature regulation and humidity control systems. The analytics engine 208 may examine this refrigerator's operational characteristics to distinguish between its active and passive function, and may identify cooling cycles, compressor operations, and rapid cooling as the primary usage parameters because these are directly related to the refrigerator's primary function of maintaining optimal food storage conditions. Additionally, the analytics engine 208 may note that this particular refrigerator model has a defrost cycle that runs periodically to prevent ice build-up, as well as a humidity control system to keep food items fresh. These additional functions may be crucial for efficient operation of the refrigerator and thus may also be categorized by the analytics engine 208 as primary usage parameters. In contrast, passive functions such as door-open-close events and idle energy consumption may be monitored by the analytics engine 208 to assess overall energy efficiency, but these parameters may not be the main focus. The analytics engine 208 may then use data from similar IoT device profiles and a preexisting database to validate these parameters to ensure accurate and industry-standard classification of the parameters. In this type of real-world scenario, accurately identifying and monitoring the primary usage parameters enables the IoT device usage monitoring system 102 to generate more precise IoT device recommendations for optimizing energy use. For example, the analytics engine 208 may generate IoT device recommendations suggesting the adjustment of the defrost cycle frequency or optimizing the humidity control settings based on observed usage patterns and energy consumption data, ultimately helping the user reduce electricity costs by improving the efficiency of the refrigerator.

As shown by operation 404, the apparatus 200 includes means such as analytics engine 208, or the like, for determining, based on the primary parameter and the secondary parameter, a usage type ratio. Based on the criticality of the primary usage parameter and the secondary usage parameter, the analytics engine 208 assigns a weight to each of the primary usage parameters and secondary usage parameters. Primary usage parameters, being more critical to the core functionality of an IoT device may be assigned a higher weight compared to a secondary usage parameter. In general, the usage type ratio may be determined based on a calculation that calculates the proportion of time and resources an IoT device spends on primary versus secondary activities. The analytics engine 208 may access a preexisting IoT device type database as described above to extract an average usage value for each primary usage parameter and each secondary usage parameter. In some embodiments, the analytics engine 208 may also consider contextual factors such as the IoT environment in which the IoT device operates, user behavior, and specific device features when determining an appropriate usage value and weight for each primary usage parameter and secondary usage parameter. The analytics engine 208 may then be configured to calculate an aggregate primary usage parameter weight for the primary usage parameters and an aggregate secondary usage parameter weight for the secondary usage parameters and may subsequently perform a standard normalization operation to ensure the weights sum up to 100%. In some embodiments, the analytics engine 208 may calculate the usage type ratio for the primary usage parameters using the following formula:

$$( primary usage type ratio ) = \frac{p r imary usage parameter value}{total usage parameter value} * 100$$

Similarly, the analytics engine 208 may calculate the usage type ratio for the secondary usage parameters using the following formula:

$$( secondary usage type ratio ) = \frac{secondary usage parameter value}{total usage parameter value} * 100$$

Tus the usage type ratio may be calculated as follows:

$$( usage type ratio ) = primary usage type rato : secondary usage type ratio$$

Based on the calculated usage type ratio, the analytics engine 208 may determine a protocol that allocates monitoring resources accordingly. If primary usage parameter 2 shows higher activity or importance than primary usage parameter 1, more resources may be dedicated by the analytics engine 208 to monitoring primary usage parameter 2. Similarly, as shown in the below table, if the primary usage parameter is active 70% of the time and the secondary usage parameter is used 30% of the time, the allocation of the monitoring resources of the analytics engine 208 may follow a similar 70-30 split.

| IoT Device | | Primary/ | Importance | Parameter |
|---|---|---|---|---|
| Type | Usage Parameter | Secondary | Rank | Weight |
| Refrigerator | Cooling Cycles | Primary | 1. High | 70% |
| Refrigerator | Compressor Run | Primary | 2. High | 70% |
| | Time | | | |
| Refrigerator | Door Open/ | Secondary | 3. Medium | 30% |
| | Close Events | | | |
| Refrigerator | Idle Energy | Secondary | 4. Medium | 30% |
| | Consumption | | | |

As an additional implementation, in some embodiments, the analytics engine 208 may employ a generative machine learning model that continuously learns and adjusts weights of the primary usage parameters and the secondary usage parameters based on real-time data and emerging usage patterns to ensure that the weights remain accurate and reflective of actual IoT device performance and user behavior over time. Such a feedback loop enables the analytics engine 208 to regularly update the parameter weights based on ongoing monitoring and analysis of IoT device usage, where user input and new data insights can contribute to refining the parameter weights.

As shown by operation 406, the apparatus 200 includes means such as analytics engine 208, or the like, for determining, using the generative machine learning model, the protocol based on the usage type ratio. The analytics engine 208 may feed the determined usage type ratio into a generative machine learning model as input data. The generative machine learning model may process the input data, using the patterns and correlations represented by the usage type ratio to generate a customized monitoring protocol for the particular IoT device. The generative machine learning model considers the importance of the primary usage parameter and the secondary usage parameter as indicated by the usage type ratio to allocate monitoring resources and set monitoring priorities. By way of continued example, the generative machine learning model prioritizes monitoring of the primary usage parameter (cooling cycles of the smart refrigerator), over the secondary usage parameter (door open/close events of the smart refrigerator). Additionally, the generative machine learning model may determine the frequency, methods, and resource allocation for monitoring each usage parameter. For example, the primary usage parameter of cooling cycles may be monitored every 5 minutes and the metrics monitored may include compressor run time and temperature fluctuations. In such cases, the communications hardware 206 may be configured to trigger an alert should the cooling efficiency drop below a predefined threshold. Alternatively, the secondary usage parameter of door open/close events may be monitored every 15 minutes and the metrics monitored may include door open/close frequency and duration of door openings. Similar to the above, the communications hardware 206 may be configured to trigger an alert should the door open frequency exceed a predefined limit. In general, the protocol, when executed, enables the analytics engine 208 to perform continuous monitoring and analysis of both the primary usage parameter and the secondary usage parameters for a particular IoT device. In some embodiments, the analytics engine 208 may feed the generative machine learning model with new usage data to continuously refine the protocol. In some embodiments, the protocol may adjust monitoring resources based on predicted usage patterns. For instance, if the refrigerator is expected to be a high-traffic area during specific times of the day (e.g., during typical lunch and/or dinner hours), the protocol may be adjusted to account for more frequent door open/close events at those particular times.

Returning to FIG. 3, as shown by operation 306, the apparatus 200 includes means such as analytics engine 208, or the like, for monitoring, based on the protocol, the usage of the IoT device. The analytics engine 208 may monitor usage of the IoT device by leveraging various methods and technologies, including sensors, APIs, and/or the like. In cases where an IoT device is equipped with built-in sensors that collect data related to their operation (e.g., a smart refrigerator may have temperature sensors, door sensors, and compressor activity sensors), the analytics engine 208 may extract the usage data collected by those sensors to perform subsequent operations. The analytics engine 208 may be configured to interface with the API of the IoT devices and query the internal system of the IoT device for extracting such usage data. Based on the monitoring intervals specified in the protocol, the analytics engine 208 may initiate API calls to the IoT device at the specified intervals to fetch real-time usage data, and continuously monitor the incoming data against predefined thresholds specified in the protocol. In some embodiments, the analytics engine 208 may also use third-party APIs to gather supplementary usage data, such as environmental conditions or user behavior patterns. In embodiments where anomalies or unusual usage patterns are detected in the usage data, the analytics engine 208 may cause the communications hardware 206 to trigger an alert to a user interface of the IoT device 110A, a user device 112A, and/or a third-party device 114A.

In some embodiments, monitoring usage of the IoT device may further comprise outputting, by the communications hardware 206, the usage of the IoT device to an IoT device user interface, wherein the IoT device user interface is associated with any IoT device hosted by the IoT network. The analytics engine 208 may aggregate usage data from all IoT devices within the IoT network into a centralized data repository associated with the IoT device usage monitoring system 102. This centralized data repository may store real-time usage data and historical usage data for all IoT devices within the IoT network, which may be accessible any time by a user when requested. In some embodiments, upon receipt of a user access request from an IoT device user interface associated with any IoT device hosted by the IoT network, the analytics engine 208 may cause communications hardware 206 to output the usage data of the requested IoT device to the IoT device user interface from which the user access request was submitted.

As shown by operation 308, the apparatus 200 includes means such as analytics engine 208, or the like, for generating, in response to monitoring the usage of the IoT device, using a generative machine learning model and based on the usage of the IoT device, an IoT device recommendation for the IoT device. The analytics engine 208 may collect and analyze various data points from the usage data to generate an IoT device recommendation. In some examples, data points that the analytics engine 208 may collect and analyze include energy consumption data, such as kilowatt-hours (kWh)—the total energy consumed by the IoT device over a specific period of time, power draw (Watts)—instantaneous power usage at different times of the day, electricity cost—calculated based on local utility rates, the energy consumption of the IoT device, and/or the like. In some examples, data points that the analytics engine 208 may collect and analyze include usage patterns, such as frequency and duration of operational cycles (e.g., cooling cycles in a refrigerator), activity logs (e.g., door open/close events), and/or the like. In some examples, data points that the analytics engine 208 may collect and analyze include environmental data, such as ambient temperature (e.g., surrounding temperature which may affect the efficiency of the IoT device), environmental humidity levels, and/or the like. In some examples, data points that the analytics engine 208 may collect and analyze include IoT device performance metrics such as efficiency ratios (e.g., energy efficiency index that compares the consumption of the IoT device's energy to standard benchmarks), operational health (e.g., indicators of IoT device health and performance such as error rates or maintenance alerts), and/or the like. In some examples, data points that the analytics engine 208 may collect and analyze include user preferences, such as user-defined settings (e.g., preferred cooling temperature for a refrigerator), behavioral patterns influencing IoT device usage (e.g., frequent refrigerator door openings), and/or the like. In some examples, data points that the analytics engine 208 may collect and analyze include original purchase price of the IoT device, depreciation of the IoT device, IoT device replacement cost, IoT device repair cost, IoT device consumable cost (e.g., air filter cost, water filter cost), fuel costs (e.g., for gas appliances, lawn mowers, vehicles, etc.), solar panel based electrical savings, and/or the like.

As described in the examples below, IoT device recommendations may help users manage their IoT devices more effectively by providing actionable insights for energy consumption, maintenance, lifespan planning, and optimal IoT device selection based on usage patterns.

In some embodiments, the analytics engine 208 may monitor the usage operational data of the smart refrigerator, including the lifespan of the water filter. The analytics engine 208 may determine when the water filter is approaching the end of its effective period based on predefined thresholds or historically available data for this particular IoT device type. Upon identifying that the water filter needs replacement, the analytics engine 208 may feed this data to the generative machine learning model, which may generate an IoT device recommendation for replacing the water filter in order to maintain water quality and IoT device performance.

In some embodiments, the analytics engine 208 may analyze the performance metrics and usage data of the smart refrigerator over time and compare this data against industry standards and historical data to estimate the remaining operational life of the IoT device. When the data indicates that the refrigerator is nearing the end of its expected lifespan, the analytics engine 208 may feed this data to the generative machine learning model, which may generate an IoT device recommendation advising the user to plan for a replacement refrigerator to prevent unexpected failures and ensure continued efficiency.

In some embodiments, the analytics engine 208 may evaluate the user's current usage patterns and energy consumption data and compare the determined metrics with the specifications and performance data of newer models. If the analytics engine 208 identifies potential benefits of upgrading to a more energy-efficient model that significantly reduces energy costs, the analytics engine 208 may feed this data to the generative machine learning model, which may generate an IoT device recommendation suggesting the user consider upgrading to the newer model for improved efficiency and cost savings.

In some embodiments, the analytics engine 208 may review the user's usage data, noting that advanced features of the refrigerator are underutilized. By analyzing the user's actual needs of the refrigerator and comparing them with the capabilities of different models, the analytics engine 208 may determine that a simpler, less expensive refrigerator model would be sufficient for the user. Accordingly, the analytics engine 208 may feed this data to a generative machine learning model, which may generate an IoT device recommendation advising the user to downgrade to a more suitable model to potentially save on upfront and maintenance costs.

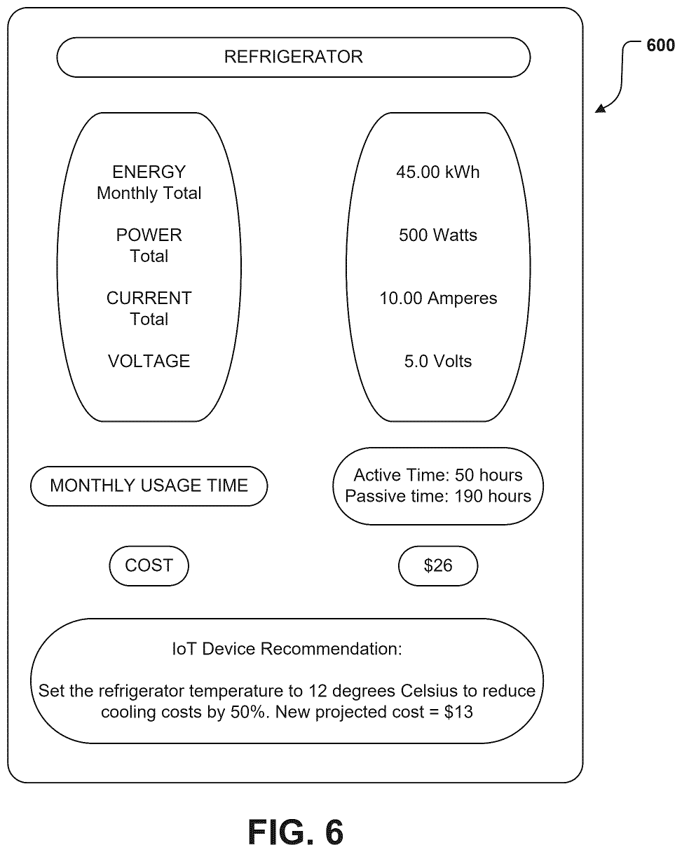

In some embodiments, generating the IoT device recommendation may occur in response to receipt of a user request, wherein the user request comprises a query associated with the IoT device. For example, consider a scenario where a user submits query seeking a recommendation that provides a solution for saving more than half of their current electricity cost for their refrigerator over the next six months. The user may submit the user request from a user interface of any IoT device 110A of the IoT network, through a user device 112A, or through a third-party device 114A. The user interface of the IoT device 110A, user device 112A, or third-party device 114A may transmit the user request with the query to the analytics engine 208, which may parse the query to extract the contextual details of the query. Assuming the analytics engine 208 has been monitoring and collecting refrigerator usage data over the past year, including historical energy consumption data (kWh), current and past usage patterns, environmental factors, user preferences and settings, the analytics engine 208 may perform an initial analysis of the historical usage data to establish a baseline of current energy consumption and usage patterns, determine the average monthly electricity cost, and identify peak consumption periods. In some embodiments, the analytics engine 208 may feed the generative machine learning model with the aforementioned usage data to simulate various usage scenarios and their impact on energy consumption (e.g., adjusting the refrigerator's internal temperature settings, reducing the frequency and duration of door openings, scheduling defrost cycles during off-peak hours). To do this, the generative machine learning model may take into account the historical usage patterns and trends, energy efficiency benchmarks for refrigerators, and potential cost-saving strategies, such as time-of-use rates for electricity. Based on the outcome of the simulations, the analytics engine 208 may generate a detailed IoT device recommendation that specifically provides a solution for the query submitted in the user request. For instance, the IoT device recommendation may recommend the user perform specific actions, such as setting the refrigerator temperature to a slightly higher level to reduce cooling costs, minimizing door openings during peak cooling periods, utilizing off-peak electricity rates for high-energy tasks, and/or the like. The IoT device recommendation may be formatted into a user-friendly report and outputted to the device from which the user request was initially submitted (e.g., user interface of IoT device 110A, user device 112A, third-party device 114A). An example of the IoT device recommendation is displayed by FIG. 6.

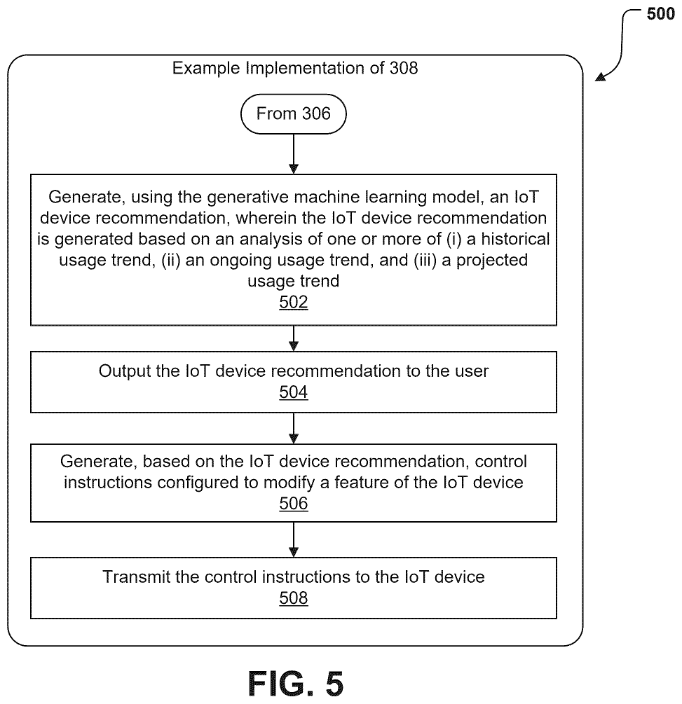

In some embodiments, operation 310 may be performed in accordance with the operations described in FIG. 5. Turning now to FIG. 5, a procedure 500 illustrates example operations for generating, using a generative machine learning model and based on the usage of the IoT device, an IoT device recommendation for the IoT device.

As shown by operation 502, the apparatus 200 includes means such as analytics engine 208, or the like, for generating, using the generative machine learning model, an IoT device recommendation, wherein the IoT device recommendation is generated based on an analysis of one or more of (i) a historical usage trend, (ii) an ongoing usage trend, and (iii) a projected usage trend corresponding to the usage of the IoT device. The analytics engine 208 may determine the historical usage trend based on an analysis of historical usage data, if available, regarding the usage and performance of the IoT device. Similarly, the analytics engine 208 may determine the ongoing usage trend based on real-time usage data that captures the current usage patterns and may determine the projected usage trend based on the historical usage data, ongoing usage data, user-specific settings, and/or expected changes in IoT device usage patterns. In some embodiments, the IoT device recommendations may comprise recommendations such as selling an IoT device to a more cost-effective and user-relevant version, upcoming cost predictions for each IoT device, predicting when new IoT devices will be added or will need replacement.

In some embodiments, the analytics engine 208 may initiate the analysis process by performing preprocessing the historical usage data and ongoing usage data to remove any anomalies or noise. The analytics engine 208 may subsequently convert the preprocessed usage data into a consistent format for analysis via standard normalization techniques and continue to aggregate the historical usage data and ongoing usage data into a comprehensive dataset to perform trend analysis. In some embodiments, the analytics engine 208 may perform trend analysis using various statistical methods and machine learning techniques to identify patterns and correlations in the historical usage data. Examples of the one or more statistical methods that may be used include: (i) descriptive statistics (e.g., central tendency measures to summarize historical usage data and ongoing usage data, standard deviation and variance to measure the dispersion of energy consumption and usage patterns, frequency distribution), (ii) time series analysis (e.g., trend analysis to identify long-term trends in the historical usage data, seasonal decomposition by deconstructing the data into seasonal components to understand recurring patterns, moving averages that smooth out short-term fluctuations to highlight longer-term trends), (iii) regression analysis (e.g., linear regression to model the relationship between energy consumption and time or other factors, multiple regression to account for the multiple variables affecting usage such as temperature, usage frequency, and ambient conditions), (iv) anomaly detection (e.g., z-score analysis to identify outliers in the data that deviate significantly from the mean, control charts that monitor ongoing data to detect deviations from expected usage patterns), and/or the like. Examples of the one or more machine learning techniques that may be used include: (i) supervised learning—regression models (e.g., linear regression, polynomial regression) to predict future energy consumption based on historical data, (ii) supervised learning—classification models (e.g., support vector machines, decision trees, random forests that categorize usage patterns into different types), (iii) unsupervised learning—clustering (e.g., k-means clustering, hierarchical clustering that demonstrate relationships between different usage patterns), (iv) unsupervised learning—principal component analysis that reduces the dimensionality of the usage data to highlight key patterns and trends), (v) time-series forecasting that models the time series usage data to predict future usage based on past trends, (vi) generative adversarial networks that generate new usage scenarios by learning the distribution of historical usage patterns, and/or the like. The analytics engine 208 may select one or more statistical methods and one or more machine learning techniques to determine the historical usage trend, ongoing usage trend, and projected usage trend based on the IoT device type.

The analytics engine 208 may feed the determined historical usage trend, ongoing usage trend, and projected usage trend as input to a generative machine learning model, which may simulate various IoT device usage scenarios to identify the impact of different usage patterns on IoT device performance and energy consumption. The generative machine learning model may identify the optimal usage pattern that balances energy, efficiency, performance, and user preferences and may translate these insights to generate a specific, actionable IoT device recommendation tailored to reduce costs, improve efficiency, meet specific user goals, and/or the like.

While the above examples are focused on a refrigerator-based implementation, operations 302-308 may follow the above process for other IoT device types, such as televisions, air conditioners, smart lights, dishwashers, and/or the like as described below.

Consider an example where the usage type ratio for a television is determined by the analytics engine 208 to be 70% primary usage parameters (e.g., on-screen time, streaming activity) and 30% secondary usage parameters (e.g., standby mode, idle power consumption), the analytics engine 208 may determine a protocol that monitors how frequently the television is used for active viewing compared to its time in standby mode. The analytics engine 208 may feed this data to a generative machine learning model for generating an IoT device recommendation, which may emphasize optimization of settings during active usage to reduce energy consumption, such as adjusting screen brightness dynamically and enabling energy-saving features. The IoT device recommendation may also recommend minimizing the duration the television remains in standby mode to further reduce overall energy usage.

As an alternate example, for an air conditioning unit, the analytics engine 208 in conjunction with the generative machine learning model may determine a protocol that focuses on primary usage parameters such as cooling cycles, compressor activity, and temperature regulator, which may account for 80% of the usage type ratio. The secondary usage parameters may include idle power consumption and system status during off-hours, representing the remaining 20% hours. The analytics engine 208 may monitor the frequency and duration of the cooling cycles and compare these parameters against the air conditioning unit's idle energy consumption. The analytics engine 208 may feed this data to a generative machine learning model for generating an IoT device recommendation, which may include optimizing the cooling schedule of the unit based on occupancy patterns, suggesting temperature adjustments for energy efficiency, and implementing period maintenance checks to ensure the system operates at peak efficiency.

As another example pertaining to smart lights, the analytics engine 208 may determine a usage type ratio of 60% primary usage parameters (e.g., lighting on-time and dimming levels) and 40% secondary usage parameters (e.g., energy consumption during periods of inactivity). The analytics engine 208 may gather data on the intensity and duration of light usage and analyze patterns of energy consumption when lights are off or in standby mode. The analytics engine 208 may feed this data to a generative machine learning model for generating an IoT device recommendation, which may include automating lighting schedules based on occupancy, adjusting dimming levels to conserve energy during non-peak hours, and using motion sensors to ensure lights are only on when needed.

As another example pertaining to dishwashers, the analytics engine 208 may determine a protocol for monitoring usage of a dishwasher based on a usage type ratio of 75% primary usage parameters (e.g., washing cycles, water temperature, energy usage during active operation) to 25% secondary usage parameters (e.g., frequency and duration of wash cycles). The analytics engine 208 may evaluate the energy and water consumption patterns and feed this data to a generative machine learning model, for generating an IoT device recommendation, which may include optimizing wash cycle setting based on load size and type, using energy-efficient modes, and scheduling washes during off-peak hours to minimize overall energy and water usage.

As shown by operation 504, the apparatus 200 includes means such as communications hardware 206, or the like, for outputting the IoT device recommendation. Once the analytics engine 208 has generated the IoT device recommendation, the communications hardware 206 may output the IoT device recommendation to the appropriate output device (e.g., IoT devices 110A-110N, user devices 112A-112N, and/or third-party devices 114A-114N). The communications hardware 206 may format the IoT device recommendation into a structured format suitable for transmission (e.g., JSON or XML) to ensure compatibility with various output devices. In some embodiments, to ensure data security and privacy, the IoT device recommendation may be encrypted using appropriate encryption protocols (e.g., AES, TLS, etc.). Following the generation of the IoT device recommendation, the communications hardware 206 may be triggered to identify the target device(s) to which the IoT device recommendation must be outputted. In some embodiments, the communications hardware 206 may output the IoT device recommendation to the device from a user request was submitted. In alternate embodiments, the communications hardware 206 may output the IoT device recommendation to the device a user has identified as the default output device. The communications hardware 206 may use established secure communications channels within the IoT network and secure internet protocols (e.g., HTTPS, MQTT) to connect with the default output device. In embodiments where the IoT device recommendation must be outputted to a third-party device 114A (e.g., a device associated with a financial planner), the communications hardware may use APIs and secure webhooks to output the IoT device recommendation. In some embodiments, the communications hardware 206 may receive an acknowledgement from the output device indicating that the IoT device recommendation has been successfully received by the IoT device. An example of an IoT device recommendation is displayed in FIG. 6.

As shown by operation 506, the apparatus 200 includes means such as analytics engine 208, or the like, for generating, based on the IoT device recommendation, control instructions configured to modify a feature of the IoT device. Control instructions refer to specific commands generated by the analytics engine 208 that are designed to modify the settings or operational parameters of an IoT device based on the generated IoT device recommendation. The analytics engine 208 may generate the control instructions by parsing the IoT device recommendation to identify the specific features to be modified (e.g., temperature setting) and the desired value (e.g., 15 degrees Celsius). The analytics engine 208 may further verify that the IoT device supports the recommended feature modification by querying the IoT device type database to confirm that the IoT device can adjust its settings to the desired value (e.g., confirming that 15 degrees Celsius is within the acceptable temperature range of the refrigerator). In some embodiments, the analytics engine 208 may generate control instructions in a format compatible with the communication protocol of the particular IoT device. Additionally, the analytics engine 208 may validate the control instructions to ensure that the control instructions conform to the command syntax of the IoT device and do not exceed any operational limits (e.g., ensures the temperature setting command does not conflict with safety parameters such as the minimum and maximum temperature limits). In some embodiments, the analytics engine 208 may encrypt the control instructions to protect against unauthorized access and tampering during transmission.

As shown by operation 508, the apparatus 200 includes means such as communications hardware 206, or the like, for transmitting the control instructions to the IoT device. Following validation and encryption of the control instructions, the communications hardware may use secure communication protocols (e.g., HTTPS, MQTT, etc.) to transmit the control instructions to the IoT device. Upon receiving the control instructions, the IoT device may decrypt the control instructions, interpret, and execute the control instructions to modify the feature as stated in the IoT device recommendation. In some embodiments, the communications hardware 206 may receive a confirmation message indicative of successful or unsuccessful execution of the control instructions.

In some embodiments, the analytics engine 208 may continue to monitor the performance of the IoT device to ensure modifying of the feature achieves the desired cost-saving effect. Any deviations or issues that are detected may be addressed through further IoT device recommendations and modifications to one or more features of the IoT device. Accordingly, the IoT device usage monitoring system 102 may operate in a continuous feedback loop.

FIGS. 3-6 illustrate operations performed by apparatuses, methods, and computer program products according to various example embodiments. It will be understood that each flowchart block, and each combination of flowchart blocks, may be implemented by various means, embodied as hardware, firmware, circuitry, and/or other devices associated with execution of software including one or more software instructions. For example, one or more of the operations described above may be implemented by execution of software instructions. As will be appreciated, any such software instructions may be loaded onto a computing device or other programmable apparatus (e.g., hardware) to produce a machine, such that the resulting computing device or other programmable apparatus implements the functions specified in the flowchart blocks. These software instructions may also be stored in a non-transitory computer-readable memory that may direct a computing device or other programmable apparatus to function in a particular manner, such that the software instructions stored in the computer-readable memory comprise an article of manufacture, the execution of which implements the functions specified in the flowchart blocks.

The flowchart blocks support combinations of means for performing the specified functions and combinations of operations for performing the specified functions. It will be understood that individual flowchart blocks, and/or combinations of flowchart blocks, can be implemented by special purpose hardware-based computing devices which perform the specified functions, or combinations of special purpose hardware and software instructions.

### CONCLUSION

As described above, example embodiments provide methods and apparatuses that enable enhanced usage monitoring of an IoT device within an IoT network, facilitating the generation of precise IoT device recommendations. Example embodiments thus overcome the shortcomings of conventional energy usage management systems by eliminating the need for manual interactions with individual IoT devices to obtain personalized recommendations. By leveraging advanced analytics and automation, example embodiments streamline the monitoring process, reducing time and resource consumption while increasing accuracy and efficiency. Furthermore, embodiments described herein are designed to adapt to emerging risks and the evolving technological landscape, ensuring that they remain effective and relevant. By automating functionality that has historically required human input not only accelerates the generation of IoT device recommendations but also introduces new capabilities, such as real-time optimization and predictive analytics of energy consumption, which were previously unavailable. Consequently, these embodiments provide technical solutions that effectively address real-world challenges, offering users opportunities to reduce the financial burden associated with their digital footprints and achieve greater energy efficiency in their personal user environments.

Additionally, by integrating sophisticated machine learning algorithms and advanced data analytics, example embodiments described herein provide users with actionable insights tailored to their specific usage patterns and needs. This enables a more nuanced understanding of energy consumption and cost-saving opportunities, which conventional energy usage monitoring systems often overlook. For instance, the ability to predict future energy usage trends and automatically adjust device settings based on these predictions allows for proactive management rather than reactive adjustments. This results in optimized performance of IoT devise, further reducing operational costs and enhancing overall energy efficiency. Moreover, the seamless integration of the advanced IoT device usage monitoring system with diverse IoT devices and platforms ensures comprehensive coverage across the entire IoT network, mitigating the fragmented usage data collection issues common in conventional approaches. By delivering precise, data-driven recommendations and streamlining the entire usage monitoring process, these embodiments not only solve existing problems but also set new standards in energy and maintenance management and associated cost reduction approaches.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

What is claimed is:

1. A method for monitoring usage of an IoT device within an IoT network, the method comprising:
receiving, by communications hardware, IoT device data comprising at least an IoT device type;
determining, by an analytics engine and based on the IoT device type, a protocol configured to monitor usage of the IoT device;
monitoring, by the analytics engine and based on the protocol, the usage of the IoT device; and
in response to monitoring the usage of the IoT device:
generating, by the analytics engine and using a generative machine learning model and based on the usage of the IoT device, an IoT device recommendation for the IoT device.

2. The method of claim 1, wherein receiving the IoT device type further comprises updating, by the analytics engine, an IoT device database to include the IoT device type, wherein the IoT device database corresponds to the IoT network hosting the IoT device.

3. The method of claim 1, wherein determining the protocol further comprises:
identifying, by the analytics engine and based on the IoT device type, a primary usage parameter and a secondary usage parameter associated with the IoT device;
determining, by the analytics engine and based on the primary usage parameter and the secondary usage parameter, a usage type ratio; and
determining, by the analytics engine and using the generative machine learning model, the protocol based on the usage type ratio.

4. The method of claim 1, further comprising outputting, by the communications hardware, the usage of the IoT device to an IoT device user interface, wherein the IoT device user interface is associated with any IoT device hosted by the IoT network.

5. The method of claim 1, wherein generating the IoT device recommendation further comprises:
generating, by the analytics engine and using the generative machine learning model, an IoT device recommendation, wherein the IoT device recommendation is generated based on an analysis of one or more of (i) a historical usage trend, (ii) an ongoing usage trend, and (iii) a projected usage trend corresponding to the usage of the IoT device; and
outputting, by the communications hardware, the IoT device recommendation.

6. The method of claim 1, wherein generating the IoT device recommendation occurs in response to receipt of a user request, wherein the user request comprises a query associated with the IoT device.

7. The method of claim 1, further comprising:
generating, by the analytics engine and based on the IoT device recommendation, control instructions configured to modify a feature of the IoT device; and
transmitting, by the communications hardware, the control instructions to the IoT device.

8. An apparatus for monitoring usage of an IoT device within an IoT network, the apparatus comprising:
communications hardware configured to:
receive, IoT device data comprising at least an IoT device type;
an analytics engine configured to:
determine, based on the IoT device type, a protocol configured to monitor usage of the IoT device, and
monitor, based on the protocol, the usage of the IoT device; and
in response to monitoring the usage of the IoT device, the analytics engine is further configured to generate, using a generative machine learning model and based on the usage of the IoT device, an IoT device recommendation for the IoT device.

9. The apparatus of claim 8, wherein the analytics engine is further configured to update an IoT device database to include the IoT device type, wherein the IoT device database corresponds to the IoT network hosting the IoT device.

10. The apparatus of claim 8, wherein the analytics engine is further configured to:
identify, based on the IoT device type, a primary usage parameter and a secondary usage parameter associated with the IoT device;
determine, based on the primary usage parameter and the secondary usage parameter, a usage type ratio; and
determine, using the generative machine learning model, the protocol based on the usage type ratio.

11. The apparatus of claim 8, wherein the communications hardware is further configured to output the usage of the IoT device to an IoT device user interface, wherein the IoT device user interface is associated with any IoT device hosted by the IoT network.

12. The apparatus of claim 8, wherein the analytics engine is further configured to:
generate, using the generative machine learning model, an IoT device recommendation, wherein the IoT device recommendation is generated based on an analysis of one or more of (i) a historical usage trend, (ii) an ongoing usage trend, and (iii) a projected usage trend corresponding to the usage of the IoT device,
wherein the communications hardware is further configured to output the IoT device recommendation.

13. The apparatus of claim 8, wherein the analytics engine is further configured to generate the IoT device recommendation in response to receipt of a user request, wherein the user request comprises a query associated with the IoT device.

14. The apparatus of claim 8, wherein the analytics engine is further configured to:
generate, based on the IoT device recommendation, control instructions configured to modify a feature of the IoT device,
wherein the communications hardware is further configured to transmit the control instructions to the IoT device.

15. A computer program product for monitoring usage of an IoT device within an IoT network, the computer program product comprising at least one non-transitory computer readable storage medium storing software instructions that, when executed, cause an apparatus to:
receive IoT device data comprising at least an IoT device type;
determine, based on the IoT device type, a protocol configured to monitor usage of the IoT device;
monitor, based on the protocol, the usage of the IoT device; and
in response to monitoring the usage of the IoT device:
generate, using a generative machine learning model and based on the usage of the IoT device, an IoT device recommendation for the IoT device.

16. The computer program product of claim 15, wherein the software instructions, when executed, further cause the apparatus to update an IoT device database to include the IoT device type, wherein the IoT device database corresponds to the IoT network hosting the IoT device.

17. The computer program product of claim 15, wherein the software instructions, when executed, further cause the apparatus to:
identify, based on the IoT device type, a primary usage parameter and a secondary usage parameter associated with the IoT device;
determine, based on the primary usage parameter and the secondary usage parameter, a usage type ratio; and
determine, using the generative machine learning model, the protocol based on the usage type ratio.

18. The computer program product of claim 15, wherein the software instructions, when executed, further cause the apparatus to output the usage of the IoT device to an IoT device user interface, wherein the IoT device user interface is associated with any IoT device hosted by the IoT network.

19. The computer program product of claim 15 wherein the software instructions, when executed, further cause the apparatus to:
generate, using the generative machine learning model, an IoT device recommendation, wherein the IoT device recommendation is generated based on an analysis of one or more of (i) a historical usage trend, (ii) an ongoing usage trend, and (iii) a projected usage trend corresponding to the usage of the IoT device; and
output the IoT device recommendation.

20. The computer program product of claim 15, wherein the software instructions, when executed, further cause the apparatus to:
generate, based on the IoT device recommendation, control instructions configured to modify a feature of the IoT device; and
transmit the control instructions to the IoT device.
